(19) United States
(12) Patent Application Publication
(10) Pub. No.: US 2026/0024430 A1
(43) Pub. Date: Jan. 22, 2026

(54) REMOTE MONITORING SYSTEM FOR HAZARDOUS LOCATIONS

(71) Applicant: Airgas, Inc., Radnor, PA (US)

(72) Inventors: Christopher G. WILLIAMS, Radnor, PA (US); Andrew WELLINGTON, Houston, TX (US); Andrew SHURTLEFF, Houston, TX (US)

(73) Assignee: Airgas, Inc., Radnor, PA (US)

(21) Appl. No.: 19/273,199

(22) Filed: Jul. 18, 2025

Related U.S. Application Data
(60) Provisional application No. 63/673,487, filed on Jul. 19, 2024.

(51) Int. Cl. G08B 26/00; G08B 21/16; G08B 25/10

(52) U.S. Cl. CPC G08B 26/007; G08B 21/16; G08B 25/10

(57) ABSTRACT

A remote monitoring system for hazardous locations, including one or more remote transmitters, a signal concentrator, wherein the signal concentrator is configured to communicate with the one or more remote transmitters, an antenna wherein the antennas is configured to communicate with the signal concentrator and also to communicate with the cloud, and a sealed, explosion proof enclosure comprising one or more antenna barriers each with one terminal accessible from the inside of the sealed, explosion proof enclosure and the other terminal accessible from the outside of the sealed, explosion proof enclosure.

### CROSS REFERENCE TO RELATED APPLICATIONS

This application claims the benefit of priority under 35 U.S.C. § 119 (a) and (b) to U.S. Provisional Patent Application No. 63/673,487, filed Jul. 19, 2024, the entire contents of which are incorporated herein by reference.

### BACKGROUND

Recently, developments have been made in the remote monitoring of gases, including hazardous or flammable gases, so they may now be performed in areas that have been classified as Hazardous or Non-Hazardous. Using proprietary devices, processes, and communication protocols, these remote devices transmit data to Concentrators which receive information from the remote devices and communicate with a cloud service (via cellular, WiFi, or other appropriate means).

The current state of the art is such that the Concentrators are not C1D1 or C1D2 rated, so these Concentrators currently must be carefully located in areas that are not classified as Hazardous. This is a serious limitation and has prevented a number of potential installations, in which there are no suitable “safe” placement locations within the somewhat limited transmission range of the remote devices.

Thus, there is a need in the industry for a safe, cost-effective, technically sound, and viable solution to this problem.

### SUMMARY

A remote monitoring system for hazardous locations, including one or more remote transmitters, a signal concentrator, wherein the signal concentrator is configured to communicate with the one or more remote transmitters, an antenna wherein the antenna is configured to communicate with the signal concentrator and also to communicate with the cloud, and a sealed, explosion proof enclosure comprising one or more antenna barriers each with one terminal accessible from the inside of the sealed, explosion proof enclosure and the other terminal accessible from the outside of the sealed, explosion proof enclosure.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation in accordance with one embodiment of the present invention.

FIG. 2 is a schematic representation in accordance with another embodiment of the present invention.

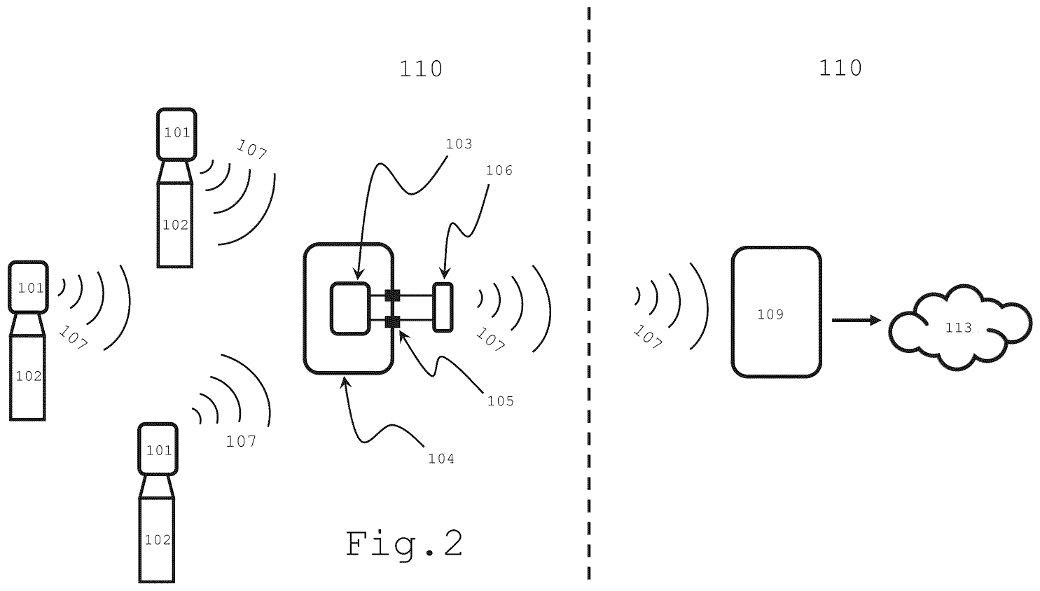

### ELEMENT NUMBERS

101=remote transmitter
102=compressed gas cylinder
103=signal concentrator
104=sealed, explosion proof enclosure
105=antenna barrier
106=antenna
107=WIFI signal
108=cellular signal
109=receiver
110=classified area
111=unclassified area

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

As used herein, the term “Class 1 Division 1” or “C1D1” is defined as the specification of a hazardous location where flammable gases, vapors or liquids may be present in concentrations that could result in ignition under normal or frequent operating conditions. Such locations require very specific safety considerations, including explosion proof equipment and enclosures as well as special ventilation.

As used herein, the term “Nema 7” is defined as an electrical enclosure designed for use in locations such as C1D1 and are designed to be explosion proof.

As used herein, the term “explosion proof” is defined as being capable of containing an internal explosion without presenting an external hazard.

As used herein, the term “wireless concentrator” is defined as a device that gathers traffic from multiple wireless access points or transmitters and consolidates them into a single data stream.

The current invention features proprietary communications protocols (but may be modified to use other industrial standard communications protocols), as well as cellular (or WiFi) communications. The current invention is fully C1D1 certified (presuming a NEMA 7 Enclosure) and uses readily available 110v power. The current invention comprises an external antenna that is FCC compliant as well as compliant with the immediate Area Rating.

The remote transmitters are located in a classified area. They transmit a wireless signal to a wireless concentrator, which is also located within the classified area. The wireless concentrator then transmits a signal to an external receiver (such as a cloud service) which is located outside of the classified area. The external receiver may be up to 60 feet from the wireless concentrator. The explosion proof antenna barriers allow direct and remote mounting within, extending into, or traversing a hazardous location.

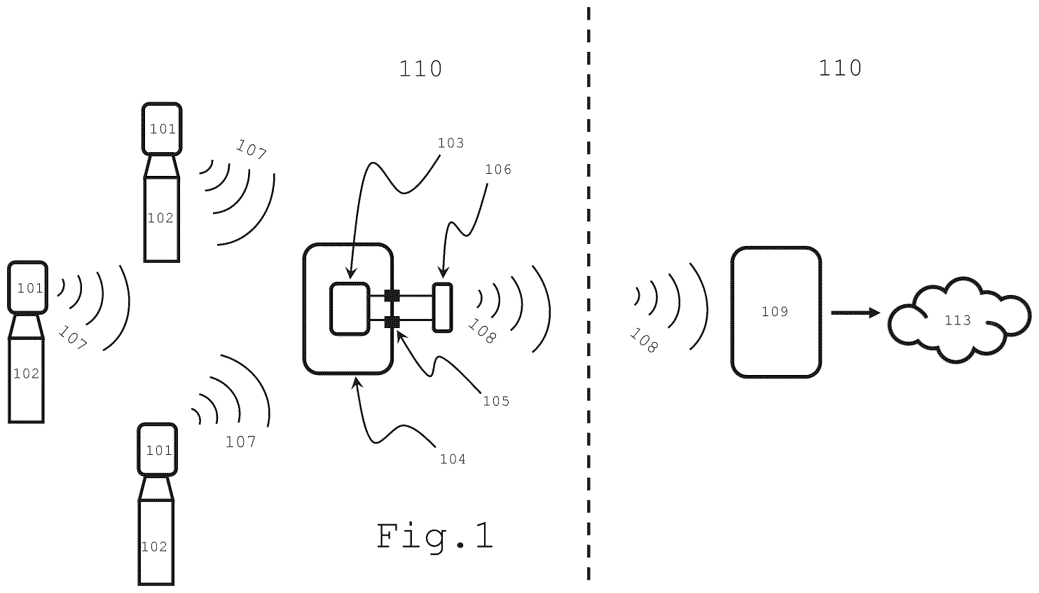

Turning to FIG. 1, remote transmitters 101 are located as required within classified area 110. Classified area 110 may be classified as a Class 1, Division 1 hazardous location. Remote transmitters 101 may be pressure, temperature or flow transmitters that may be attached to compressed gas cylinder 102. Signal concentrator 103 is located in proximity to remote transmitters 101. In one embodiment, if classified area 110 is indoors, remote transmitters 101 are within 100 feet of signal concentrator 103. In another embodiment, if classified area 110 is outdoors, remote transmitters 101 are within 300 feet of signal concentrator 103.

Signal concentrator 103 is positioned within sealed, explosion proof enclosure 104. Sealed, explosion proof enclosure 104 is located within classified area 110. At least two antenna barriers 105 are attached to sealed, explosion proof enclosure 104, penetrating one wall. The at least two antenna barriers 105 are each positioned with one connection terminal available on the inside of sealed, explosion proof enclosure 104 and one connection terminal available on the outside of sealed, explosion proof enclosure 104. Signal concentrator 103 is attached to the connection terminal located on the inside of sealed, explosion proof enclosure 104. Antenna 106 is located outside of sealed, explosion proof enclosure 104, and thus within classified area 102. Antenna 106 is attached to the connection terminal located on the inside of sealed, explosion proof enclosure 104.

In normal operation, remote transmitters 101 monitor the pressure, temperature within compressed gas cylinders 102 (or the flow of gas within the system) within classified area 110, and transmit this data to signal concentrator 103, located within sealed, explosion proof enclosure 104. Signal concentrator 103 either continuously or intermittently sends this concentrated data from the inside of sealed, explosion proof enclosure 104, through the at least two antenna barriers 105 to antenna 106. Antenna 106 then sends this concentrated data from inside classified area 102 to receiver 109 located in unclassified area 111, then stored in cloud 103. Thus, cylinder data from within classified area 110 is safely collected and retrieved outside of classified area 111. Thereby providing intrinsically safe monitoring of the gas cylinders content and activities.

What is claimed is:

1: A remote monitoring system for hazardous locations, comprising:
one or more remote transmitters,
a signal concentrator, wherein the signal concentrator is configured to communicate with the one or more remote transmitters,
an antenna wherein the antennas is configured to communicate with the signal concentrator and also to communicate with the cloud,
a sealed, explosion proof enclosure comprising one or more antenna barriers each with one terminal accessible from the inside of the sealed, explosion proof enclosure and the other terminal accessible from the outside of the sealed, explosion proof enclosure;
wherein the signal concentrator is positioned inside the sealed, explosion proof enclosure, and is connected to the one or more antenna barriers,
wherein the antenna is positioned on the outside of the sealed, explosion proof enclosure, and is connected to the one or more antenna barriers.

2: The remote monitoring system for hazardous locations of claim 1, wherein the one or more remote transmitter is approved for use in a Class 1, Division 1 hazardous location.

3: The remote monitoring system for hazardous locations of claim 1, wherein the sealed, explosion proof enclosure is approved for use in a Class 1, Division 1 hazardous location.

4: The remote monitoring system for hazardous locations of claim 1, wherein the one or more signal concentrator communication with the cloud is cellular or wireless.

5: The remote monitoring system for hazardous locations of claim 1, wherein the one or more signal concentrator communication with the one or more signal concentrator is wireless.

6: The remote monitoring system for hazardous location of claim 1, wherein one or more remote transmitters are pressure, temperature or flow transmitters.

7: The remote monitoring system for hazardous location of claim 1, wherein the one or more remote transmitter comprises between 1 and 25 remote transmitters.

8: The remote monitoring system for hazardous location of claim 1, wherein the one or more remote transmitters and the one or more signal concentrator are all located indoors, and are less than 100 feet apart.

9: The remote monitoring system for hazardous location of claim 1, wherein the one or more remote transmitters and the one or more signal concentrator are all located outdoors, and are less than 300 feet apart.
